(19) United States
(12) Patent Application Publication
(10) Pub. No.: US 2025/0086472 A1
(43) Pub. Date: Mar. 13, 2025

(54) EXPLAINING OPERATION OF A NEURAL NETWORK

(71) Applicant: Telefonaktiebolaget LM Ericsson (publ), Stockholm (SE)

(72) Inventors: Ahmad Ishtar TERRA, Sundbyberg (SE); Rafia INAM, Västerås (SE); Elena FERSMAN, Palo Alto, CA (US)

(73) Assignee: Telefonaktiebolaget LM Ericsson (publ), Stockholm (SE)

(21) Appl. No.: 18/727,998

(22) PCT Filed: Jan. 11, 2023
(86) PCT No.: PCT/SE2023/050031

§ 371 Date: Jul. 10, 2024

Related U.S. Application Data
(60) Provisional application No. 63/298,415, filed on Jan. 11, 2022.

(51) Int. Cl. G06N 3/092

(52) U.S. Cl. CPC G06N 3/092

(57) ABSTRACT

A computer-implemented method is provided. The method comprises obtaining first correlation values indicating correlations between input features and reward components; obtaining reward weights for the reward components, wherein each of the reward weights indicates a contribution of each of the reward components to a total reward, and applying the reward weights to the first correlation values, thereby generating weighted correlation values which indicate weighted correlations between the input features and the reward components.

### TECHNICAL FIELD

This disclosure relates to a method and a system for explaining operation of a neural network used in reinforcement learning (RL).

### BACKGROUND

RL is a method of enabling an agent to learn from its interaction with its environment. In each step of the RL, the agent performs a specific action and gets a reward in return. The reward indicates how good the action was in terms of achieving the main goal of a task that is given to the agent.

A variant of RL is deep reinforcement learning (DRL). The DRL has been used to solve various tasks with outstanding performances. The main driving factor of high performing DRL is the utilization of deep neural network (DNN). DNN are used in many complex tasks such as identifying images, recognizing voices, generating fake videos, etc. However, the way DNN works and produces a specific output is hard to understand because each component (node) of the DNN is a mathematical operation that is constructed in a certain way which depends on the task the DNN is trying to solve.

Explainable artificial intelligence (XAI) is a method to analyze and then explain how an artificial intelligence (AI) agent works. One way to explain how an AI agent works is by showing which input feature(s) affects most to the output of the AI model. Deeplift (e.g., described in Shrikumar, Avanti, Peyton Greenside, and Anshul Kundaje. “Learning important features through propagating activation differences.” In International Conference on Machine Learning, pp. 3145-3153. PMLR, 2017) is one of XAI methods for measuring the effect/importance of the input feature(s) for every input that is fed to the AI model. For example, Deeplift can explain that small changes in some input features may have a huge impact on the AI model's prediction while big changes on some other input features do not affect the output of the AI model significantly. With this information and explanation, humans may be able to understand how the AI model would behave in other similar situations, and thus identify the input feature(s) that should be the main focus of the management in order to complete the given task.

While Deeplift focuses on explaining contribution of each input feature to a given task, explainable Reinforcement Learning via Reward Decomposition (e.g., described in Juozapaitis Z, Koul A, Fern A, Erwig M, Doshi-Velez F. Explainable Reinforcement Learning via Reward Decomposition, in roceedings at the International Joint Conference on Artificial Intelligence. A Workshop on Explainable Artificial Intelligence, 2019) is for explaining an DRL agent from the output side. This method decomposes a total reward into reward components. With this information about the reward components, humans can understand which reward component affects or contributes the most to the total reward.

### SUMMARY

However, certain challenges still exist. The existing explainable RL methods do not provide any explanation regarding the correlations between the input features and the reward components.

For example, in the existing methods, even if an input feature X1 is identified to be the most important feature with respect to a total reward, the information about the reward component(s) the input feature X1 significantly affects is unknown. Similarly, in the existing methods, even if a reward component Y1 is identified to be the reward component that contributes the most to the total reward, the information about which input feature(s) significantly affects the reward component Y1 is missing.

Because the correlations between the input features and the reward components are unknown, it may be difficult to adjust the configuration of the RL agent (i.e., identifying the inputs to adjust and adjusting the identified inputs) such that a particular reward component of the RL agent becomes improved.

Accordingly, in one aspect, there is provided a computer-implemented method. The method comprises obtaining first correlation values indicating correlations between input features and reward components and obtaining reward weights for the reward components, wherein each of the reward weights indicates a contribution of each of the reward components to a total reward. The method further comprises applying the reward weights to the first correlation values, thereby generating weighted correlation values which indicate weighted correlations between the input features and the reward components.

In another aspect, there is provided a computer program comprising instructions which when executed by processing circuitry cause the processing circuitry to perform the method of the embodiments described above.

In another aspect, there is provided a computing device. The computing device is configured to obtain first correlation values indicating correlations between input features and reward components and obtain reward weights for the reward components, wherein each of the reward weights indicates a contribution of each of the reward components to a total reward. The computing device is further configured to apply the reward weights to the first correlation values, thereby generating weighted correlation values which indicate weighted correlations between the input features and the reward components.

In another aspect, there is provided a computing device. The computing device comprises a memory; and processing circuitry coupled to the memory. The computing device is configured to perform the method of the embodiments described above.

The embodiments of this disclosure provide the following advantages:

The correlation between each input feature and each reward component can be explained by providing a correlation value indicating how much each input feature contributes to each reward component.

Reward component weight values and their effects towards the DRL agent behavior can be obtained.

For finer granularity of explanation, each reward component and/or each input features can be evaluated individually.

The last two layers of the neural network (NN) used in RL can be made transparent (i.e., the operations of the last two layers of the NN can be explained).

Vanishing and/or exploding gradient in the NN can be avoided.

Better adjustments can be made for retraining the DRL NN partially, removing non-contributing input feature(s), removing misbehave component(s), and/or tuning reward weight component values to fulfill the desired behavior, thereby improving the training time and supporting efficient resource usage.

By adjusting each reward component weight value, a trained DRL agent can be transferred to other task without retraining.

The explanation about the correlation between each input feature and each reward component can be generated during training (for local explanation) or after training (for both local and global explanation).

### BRIEF DESCRIPTION OF THE DRAWINGS

The accompanying drawings, which are incorporated herein and form part of the specification, illustrate various embodiments.

FIG. 1 shows an exemplary environment.

FIG. 2 shows a system according to some embodiments.

FIG. 3 illustrates normalized explanation data according to some embodiments.

FIG. 4 shows an exemplary environment.

FIG. 5A shows correlations between input features and a total reward.

FIG. 5B shows contributions of reward components to the total reward.

FIGS. 6A and 6B show normalized correlations between input features and reward components.

FIGS. 7A and 7B show weighted correlations between input features and reward components.

FIG. 8 shows an exemplary environment.

FIG. 9A shows correlations between input features and a total reward.

FIG. 9B shows contributions of reward components to the total reward.

FIGS. 10A and 10B show normalized correlations between input features and reward components.

FIGS. 11A and 11B show weighted correlations between input features and reward components.

FIG. 12 illustrates dataflow of generating post-hoc global explanation after training phase.

FIG. 13 illustrates Dataflow of generating real time local explanation during training phase.

FIG. 14 shows a process according to some embodiments.

FIG. 15 shows a system according to some embodiments.

FIG. 16 shows a sequence diagram of generating real time local explanation during training phase.

FIG. 17 shows a sequence diagram of generating post-hoc global explanation after training phase

### DETAILED DESCRIPTION

The embodiments of this disclosure provide a method for correlating the input features and the reward components by applying XAI methods to every component of a DRL agent. Using this method, contribution of each input feature towards each reward component can be determined.

Identifying the contribution of each input feature towards each reward component allows determining which input feature to adjust in order to change a particular reward component, and thus provides finer granularity of the explanation of the correlations. Also, in some embodiments, a weight value for each reward component towards a total reward is determined.

Therefore, the embodiments provide the following four valuable insights about an DRL agent: correlation of input-output explanation of neural network (NN); correlations between the inputs and the outputs of RL agents; prioritization of every reward component; and correlation among these three information. In other words, the explanations resulted from the embodiments explain the quality of the neural network, the quality of the RL agent, proportions of the reward components, and correlations among them.

The embodiments of this disclosure also provide a method of measuring how much the explanation provided by the embodiments satisfies the desired outcome. For example, first, a user or users may set a correlation value indicating a correlation between each input feature and each reward component, thereby generating a matrix parameterizing the correlations between the input features and the output features. Then, a weight value indicating the contribution of each reward component towards a total reward is obtained and multiplied to the generated matrix. The values of the multiplied matrix may be summed up for each reward component, thereby determining a focus value measuring of how much the desired properties are fulfilled. The mean and/or the weighted mean of all components' focus value may be calculated to quantify the whole model behavior.

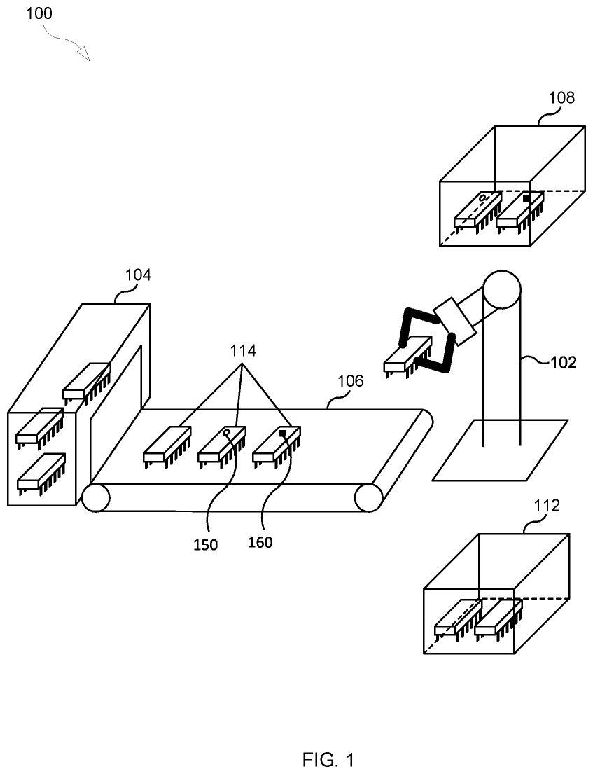

FIG. 1 shows a simplified exemplary environment 100 according to some embodiments. In the environment 100, there are provided a robot 102, a storage rack (a.k.a., a storage) 104, a conveyor belt 106, a storage rack (a.k.a., a storage) 108, and a storage rack 112. Using the conveyor belt 106, items (e.g., computer chips) 114 stored in the storage 104 are moved from the storage 104 to the storage 108 or the storage 112. The storage 108 is for collecting defective items and the storage 112 is for collecting non-defective items. The robot 102 is configured to classify the items 114 on the conveyor belt 106 into defective items and non-defective items, and place them into the storage 108 or the storage 112 according to the classification.

In order to optimize the classifying function (i.e., classifying the items 114 into defective items and non-defective items) of the robot 102, a deep reinforcement learning (DRL) may be used. For example, various input features (e.g., detecting a hole 150 in the computer chips, detecting a black spot 160 in the computer chips, etc.) may be provided to a neural network (NN) used in DRL, and based on the input features, the NN may determine whether the item 114 the robot 102 is examining is defective or not. Based on the NN's determination, the robot 102-an agent in the DRL environment-grabs and places the items 114 into the appropriate storage 108 or 112.

If the NN is perfect, the robot 102 would place all defective items 114 into the storage 108 and place all non-defective items 114 into the storage 112. Here, placing the defective items 114 into the storage 108 (which is configured to store defective items) corresponds to a reward component and placing the non-defective items 114 into the storage 112 (which is configured to store non-defective items) corresponds to another reward component.

However, because the NN is not perfect, there may be scenarios where the robot 102 places the items 114 into the wrong storage. For example, the robot 102 may place some non-defective items 114 into the storage 108 while placing some defective items into the storage 112. In such scenarios, it is desirable to revise the NN such that, in the next time, the robot 102 can correctly place the items 114 into the storage 106 or the storage 108.

In order to revise the NN correctly, it is desirable to understand how each input feature contributes to each reward component. For example, in the environment 100, it is desirable to understand how a first input feature (e.g., detecting a hole in the computer chips) contributes to a first reward component (e.g., placing a defective item into the storage 108 that is configured to store defective items—i.e., correctly classifying the item as a defective item) and how a second input feature (e.g., detecting a black spot in the computer chips) contributes to a second reward component (e.g., placing a non-defective item into the storage area 112 that is configured to store non-defective items—i.e., correctly classifying the item as a non-defective item).

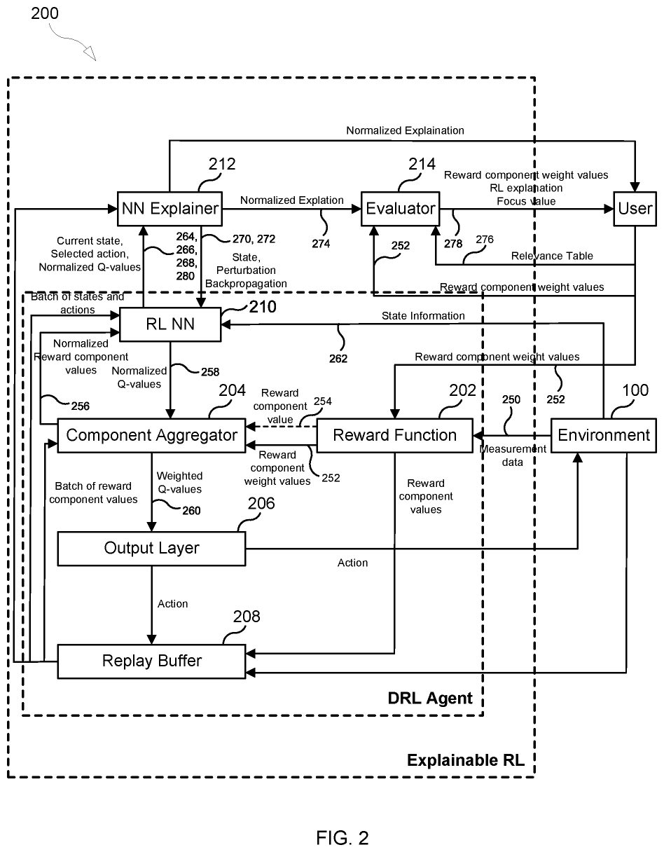

Thus, in the embodiments of this disclosure, a system 200 shown in FIG. 2 is provided. The system 200 is configured to explain how each input feature contributes to each reward component. In other words, one of the main functions of the system 200 is to improve the user's understanding about the operation of an RL agent.

As shown in FIG. 2, the system 200 comprises a reward function unit 202, a component aggregator 204, an output layer 206, a replay buffer 208, a RL NN 210, an NN explainer 212, and an evaluator 214. Each of the components 202-214 may be implemented in different hardware modules or software modules. Alternatively, in some embodiments, any two or more of the components 202-214 may be implemented into a single entity.

As shown in FIGS. 2, 16 and 17, the reward function unit 202 is configured to receive and store a reward component weight value 252 (a.k.a., a reward priority) for each reward component. The reward component weight value 252 may be set by one or more users. In some embodiments, the reward component weight value 252 may be presented in a single numeric value or in the form of a formula (e.g., quadratic, exponential, etc.).

The reward function unit 202 may also be configured to store a reward function for each reward component (e.g., identifying all defective items correctly and identifying all non-defective items correctly).

The reward component weight value 252 for each reward component indicates the importance of each reward component with respect to a total reward. For example, in some scenarios, it is more important to identify all non-defective items correctly (thus not placing non-defective items into the storage 112) than identifying all defective items correctly (thus not placing defective items into the storage 108). In such scenario, the reward component weight value 252 for the reward component of identifying all non-defective items correctly may be set to be higher than the reward component weight value 252 for the reward component of identifying all defective items correctly.

As shown in FIGS. 2, 16, and 17, the reward function unit 202 is also configured to receive measurement data 250 from the environment 100 (in which an RL agent such as the robot 102 executes an action and a reward is generated based on the executed action) and determine a reward component value for each reward component, by using the reward function, based on the measurement data 250 from the environment. For example, in the exemplary environment 100, the reward component value for a reward component may indicate a ratio of the number of the defective items placed in the storage 108 which is configured to store defective items to the number of non-defective items placed in the storage 108.

In some embodiments, the reward function of each reward component stored in the reward function unit 202 is normalized such that the reward component values calculated using the reward functions of all reward components are within the same range (e.g., [−1,1]).

The reward function unit 202 may also be configured to perform a reward prioritization process—calculating a weighted reward component value 254 for each reward component using the normalized reward component value and the reward component weight value 252. For example, a weighted reward component value 254 for a reward component may be calculated by multiplying a reward component weight value of the reward component to a normalized reward component value of the reward component. After calculating the weighted reward component value 254, the reward function unit 202 may be configured to provide the weighted reward component values 254 and the reward weights 252 to the component aggregator 204.

As further shown in FIGS. 2, 16, and 17, the component aggregator 204 is configured to receive and store in its storage (e.g., a memory) the reward component weight values 252. Additionally, the component aggregator 204 may be configured to receive the weighted reward component values 254, calculate normalized reward component values 256 by inverting the reward prioritization process performed by the reward function unit 202, and send the normalized reward component values 256 to the RL NN 210. The normalized reward component values 256 may be used to train the RR NN 210. By training the RL NN 210 using the normalized reward component values 256, vanishing and/or exploding of gradients of the NN 210 may be avoided during the training.

Even though FIG. 2 shows that the component aggregator 204 receives the weighted reward component values 254, in other embodiments, the component aggregator 204 may receive the normalized reward component values 256 from the reward function unit 202. In such embodiments, the component aggregator 204 does not need to calculate the normalized reward component values 256 (i.e., there is no need to invert the reward prioritization process performed by the reward function unit 202).

The component aggregator 204 may also be configured to receive normalized approximated Q-values 258 and apply the reward component weight values 252 to the normalized-approximated Q-values 258, thereby generating weighted-approximated Q-values 260 for each reward component. In some embodiments, the Q-values 258 are provided in the form of a Q-table.

As known in the state of the art, a Q-value indicates how useful a given action is in gaining some future reward in a given state. Table 1 provided below shows a simplified example of a Q-table including a plurality of Q-values.

TABLE 1

| | State #1 | State #2 |
|---|---|---|
| Action #1 | Q-value #11 | Q-value #12 |
| Action #2 | Q-value #21 | Q-value #22 |

Referring back to FIG. 2, the core of the deep reinforcement learning (DRL) is encoded in a NN model provided by the NN 210.

The NN 210 is configured to receive state information 262 indicating the current state of the environment 100 and select an action to be performed by an agent (e.g., the robot 102) based on the received state information 262 using a Q-table or NN parameters stored in the NN 210. For example, in the Table 1 above, if the Q-value #11 is greater than the Q-value #21, in case the state information 262 indicates that the current state is the state #1, then the NN 210 would select the Action #1 which provides a higher Q-value. Then the NN 210 may send to the NN explainer 212 action information 264 indicating the selected action and state information 266 indicating the current state.

Also as discussed above, during the training of the NN 210, the component aggregator 204 may be configured to send the normalized reward component values 256 to the NN 210. By training the NN 210 using the normalized reward component values 260, vanishing and/or exploding of gradients of the NN 210 may be avoided during the training.

The NN 210 may also be configured to send to the NN explainer 212 normalized-approximated Q-values 268 for each reward component. For example, in case a total reward consists of a first reward component and a second reward component, the NN 210 may send to the NN explainer 212 a first Q-table or first sub-NN for the first reward component and a second Q-table or second sub-NN for the second reward component.

The NN explainer 212 is configured to explain the correlation between the action selected by the NN 210, which is indicated in the action information 264 and each reward component. The explanation of the correlation can be generated using either a perturbation method or a backpropagation method.

Historical data indicating how the state of the environment 100 will be changed based on a given action may be stored in the NN explainer 212. Thus, in the perturbation method, after receiving the action information 264 and the state information 266 from the NN 210, using the stored historical data, the NN explainer 212 may determine modified state information which indicates a modified state following the current state assuming that the action selected by the NN 210 is executed in the current state.

The modified state information may be determined using various strategies such as a) baselining each of the input features at a time and determine which input feature produces a significant effect (the baseline can be zero or mean value); b) adding random noise to each of the input features at a time and determine which input feature produces a significant effect; c) taking a random value from the (recorded) dataset for each of the features at a time and determine which input feature produces a significant effect.

After the determination, the NN explainer 212 may send perturbation data 270 and state information 272 indicating the modified state information. After receiving the perturbation data 270 and/or the state information 272, the NN 210 may calculate normalized Q-values of the perturbation data 270 and send the calculated normalized Q-values. These steps of modifying the state information, sending the perturbation data and the modified state information, and calculating the normalized Q-values of the perturbation data 280, and sending the calculated normalized Q-values associated with the transmitted backpropagation data may be repeated a predetermined number of times.

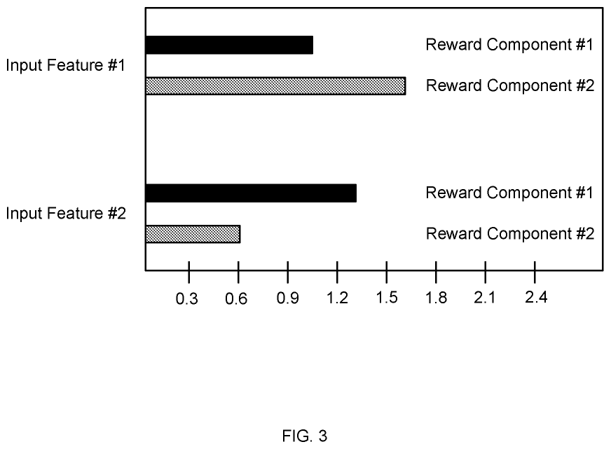

After the repetition, the NN explainer 212 may output normalized explanation data 274. The normalized explanation data 274 indicates how each input feature contributes to each reward component without considering the reward component prioritization. FIG. 3 illustrates what the normalized explanation data indicates.

Instead of the perturbation method, the backpropagation method may be used. In the backpropagation method, when the state information 262 is given to the RL NN 210, the gradient of each weight on every node of the NN 210 is calculated. The gradients of the involved nodes (from every input to the output) are then calculated using different strategies to find the input feature that goes through the weight with high gradient. The gradient can be obtained by calculating the differential of the function or approximating it using a certain value around the input feature.

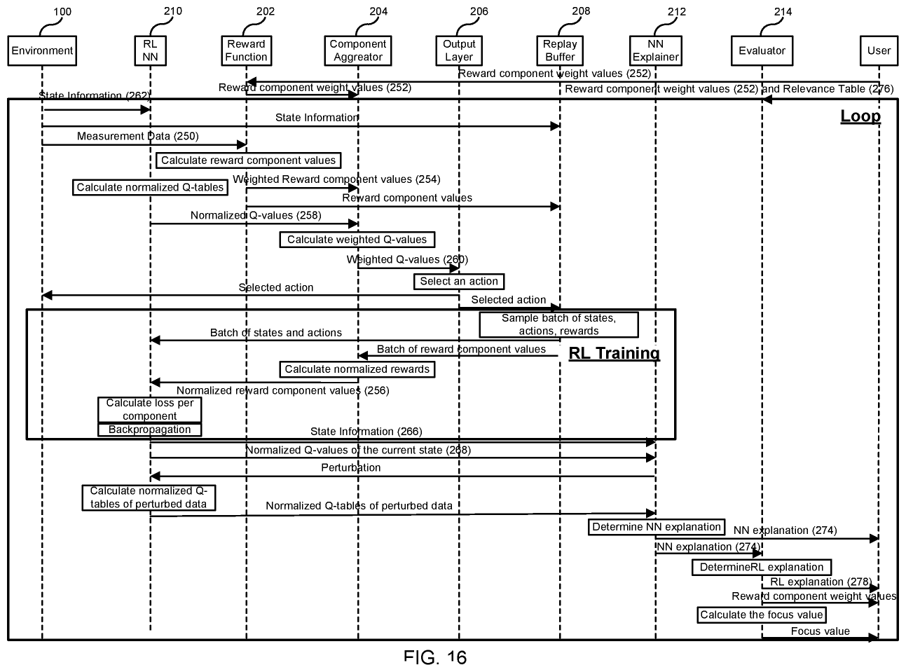

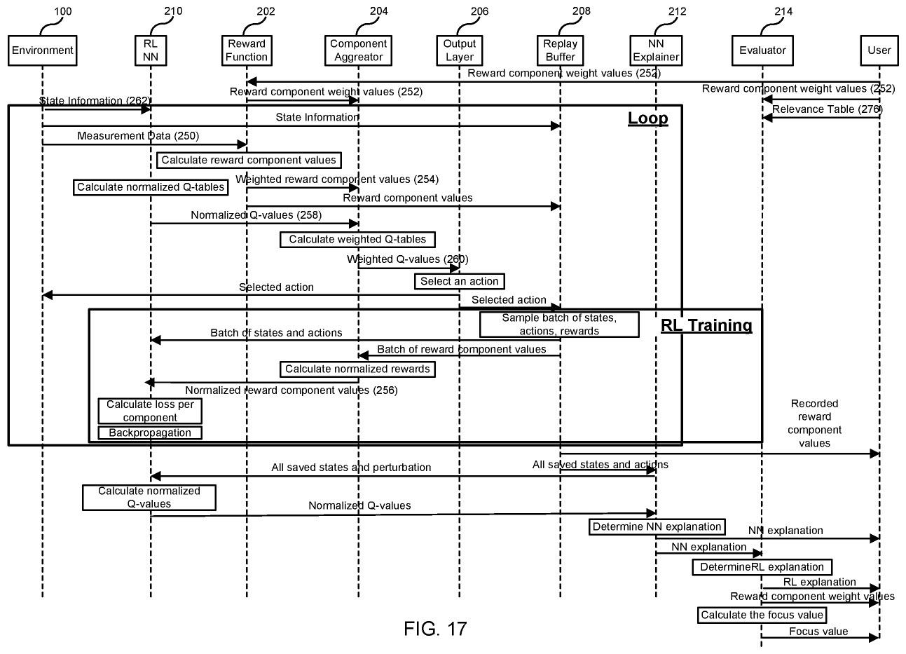

Referring back to FIG. 2, as shown in FIGS. 16 and 17, the evaluator 214 is configured to receive and store the reward weight component values 252 and relevance data 276 indicating relationships between each of the input features and each of the reward components. The relevance data 276 may be provided in the form of a table (a.k.a., a relevance table), for example, a matrix (a.k.a., a relevance matrix Nᵢⱼ). Table 1 below shows an example of a relevance table for the environment 100 shown in FIG. 1.

| | Reward Component #1 (Correctly | Reward Component #2 (Correctly |
|---|---|---|
| | classifying the computer chip as a | classifying the computer chip as a |
| | defective computer chip) | non-defective computer chip) |
| Input feature #1 (Detection of a | 0.9 | 0.5 |
| hole in a computer chip) | | |
| Input feature #2 (Detection of a | 0.4 | 0.75 |
| black spot in the computer chip) | | |

In the table 1 above, each row represents an input feature and each column represents a reward component (or vice versa). One or more users may initially set the correlation values between the input features and the reward components. Thus, the user may send to the evaluator 214 the relevance 276 including the relevance table. In the table 1, the correlation value is set to be between 0 and 1 where the value of 1 indicates full relevancy between the corresponding input feature and the corresponding reward component. Even though table 1 shows that the correlation value is between 0 and 1, in some embodiments, the correlation value may be set to be in a different range.

The evaluator 214 may apply the reward component weight values 252 to the NN explanation data 274 to generate RL explanation data (a.k.a., weighted explanation data) 278 and send the weighted explanation data 278 to the user. The weighted explanation data 278 indicates a weighted contribution of each input feature towards each reward component. The weighted explanation data 278 may be provided in the form of a table, for example, a matrix (a.k.a., an explanation matrix Mᵢⱼ)

The evaluator 214 may also be configured to calculate a focus value by performing an element-wise multiplication between Mᵢⱼ and Nᵢⱼ, and then calculating an average of the values of the matrix elements per each reward

$$( i . e . , {F}_{j} = \frac{{\sum }_{i} {M}_{ij} ⊙ {N}_{ij}}{{\sum }_{i} {M}_{ij}} ) .$$

In addition to the focus value, unweighted and weighted mean values may also be calculated. The unweighted mean value (U) is merely the mean value of all components

$$( U = \frac{{\sum }_{j} {F}_{j}}{j} )$$

while the weighted mean (W) is calculated based on the focus values for all reward components and the reward component weight values. For example,

$$W = \frac{{\sum }_{j} {F}_{j} \cdot {R}_{j}}{{\sum }_{j} {R}_{j}}$$

where Rⱼ is the reward component weight value for j-th reward component.

The output layer 206 is configured to receive the weighted Q-values 260 from the component aggregator 204 and sum up all reward component values. Based on the sum of all reward component values, the output layer 206 is configured to select an action that maximizes the total reward during the exploitation phase.

The replay buffer 208 is configured to record all of the states, actions, and reward values during the training of the NN. During the training, the replay buffer 208 is configured to sample a batch amount of the stored states, actions, and rewards in order to update the RL NN parameters. The reward values recorded in the replay buffer 208 may be normalized through the component aggregator 204 such that the NN 210 receives the normalized reward values 256.

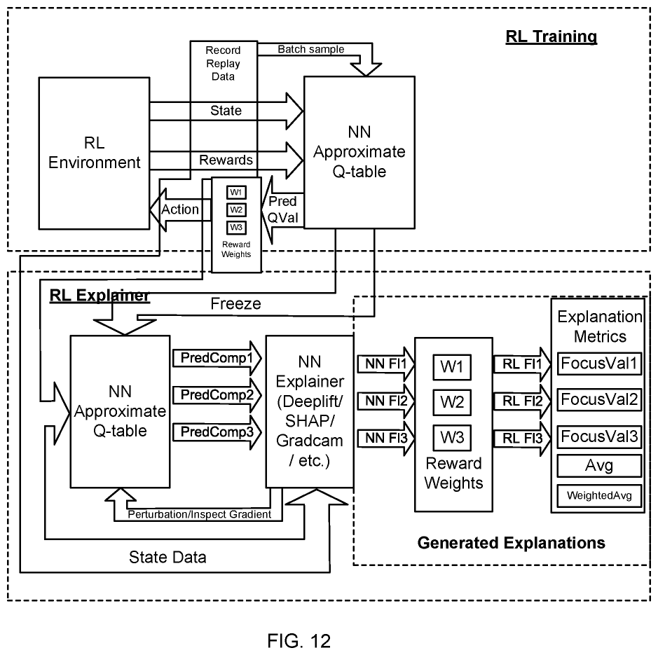

According to some embodiments, the system 200 may be used for both global explanation and local explanation. The global explanation summarizes the RL agent's behavior in encountering various situations. FIG. 17 shows a sequence diagram of generating post-hoc global explanation after training phase. As shown in FIG. 17, in generating the global explanation, the replay buffer 208 may send all the recorded states and actions to the NN 210. The NN 210 can generate prediction using the trained model without necessarily executing the action. Based on the prediction and the selected action, the NN explainer 212 may generate the global explanation for every state (after training (post-hoc) as illustrated in FIG. 12.

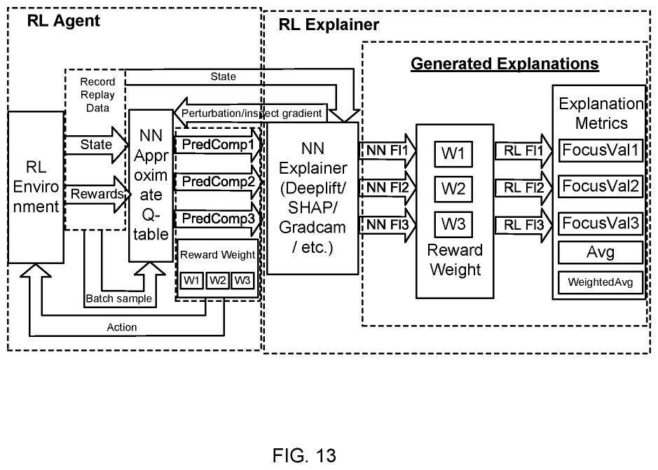

FIG. 16 shows a sequence diagram of generating real time local explanation during training phase. The local explanation informs the input features affecting a particular decision or prediction. Contrary to the global explanation which is generated after the training, the local explanation is generating during the training as illustrated in FIG. 13. Using the local explanation, user(s) can evaluate every decision taken by the RL agent during the training and may take an immediate action (e.g., adjusting the NN or removing certain input features) if needed.

The system 200 can be used in any DRL implementation.

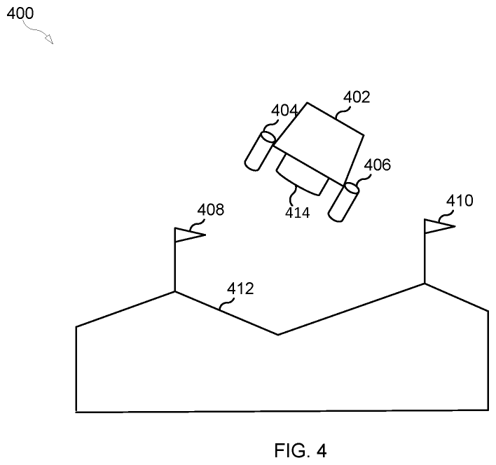

For example, FIG. 4 shows an DRL environment 400 in which the system 200 can be used. In the DRL environment 400, a lunar lander 402 is simulated and the RL agent is configured to control the lunar lander 402 in order to land the lunar lander 402 between two flags 408 and 410. More specifically, the RL agent is configured to control the lunar lander 402's left engine 404, right engine 406, and center engine 414.

In the environment 400, the input features of the RL agent are the horizontal coordinate, the vertical coordinate, the horizontal speed, the vertical speed, the current angle, the current angular speed, and the legs contact status (i.e., whether the lander 402's legs are touching surface 412 or not) of the lunar lander 402.

In the normal RL/DRL method, the reward for the RL agent is given as a single value considering all factors such as the resulted position, velocity, angle, legs status, main and side engine activity of the lander 402. However, in the embodiments of this disclosure, the reward is decomposed into various reward components.

In the environment 400, the action to be determined by the RL agent for controlling the lunar lander 402 is any one of one of the following operations: firing up the left engine 404, firing up the center engine 414, or firing up the right engine 406.

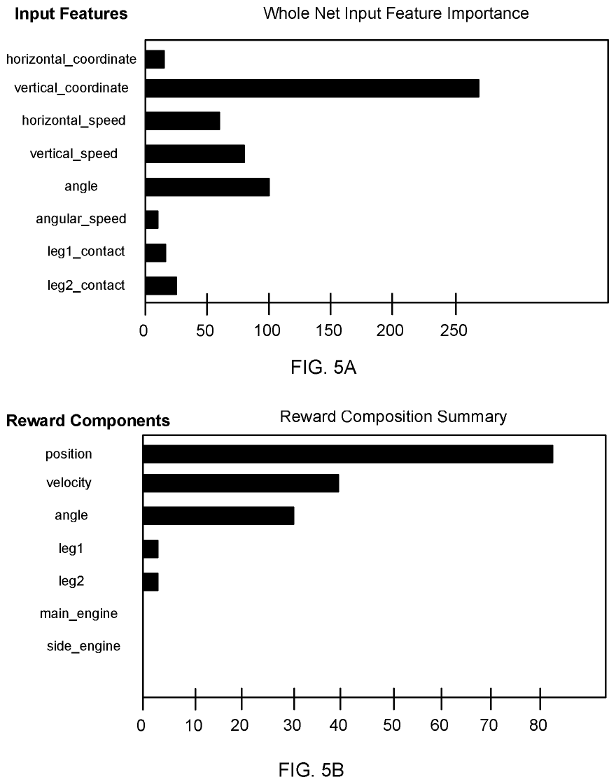

As shown in FIG. 5A, without using the system 200, only the contribution of each input feature to the total reward can be determined. Similarly, as shown in FIG. 5B, without using the system 200, only the contribution of each reward component to the total reward can be determined. In other words, without using the system 200, the contribution of each input feature to each reward component of the total reward cannot be determined.

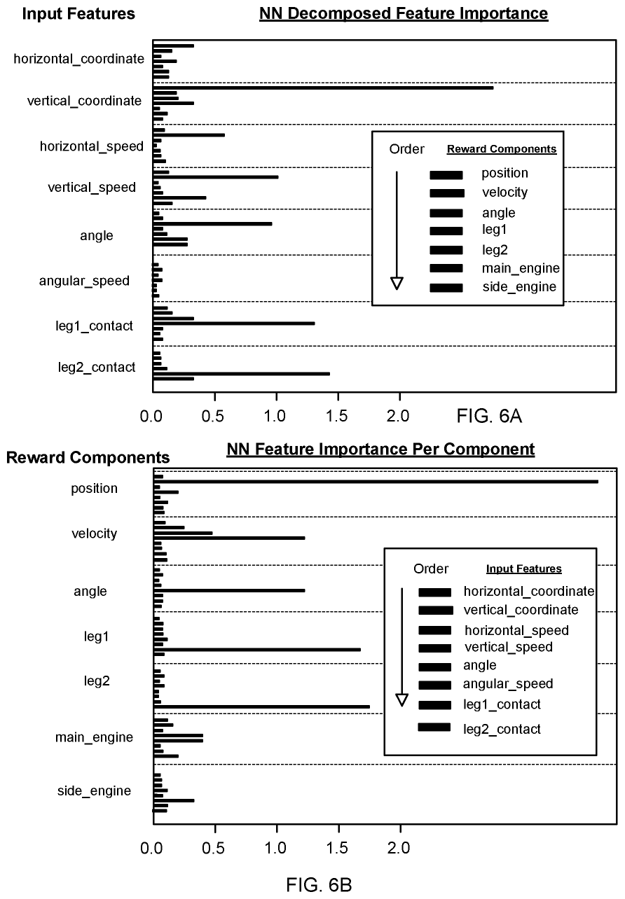

On the contrary, in the embodiments of this disclosure, using the system 200, the contribution of each input feature to each reward component can be determined as illustrated in FIGS. 6A and 6B, and thus the performance of the NN without considering the contribution of each reward component towards the total reward can be explained.

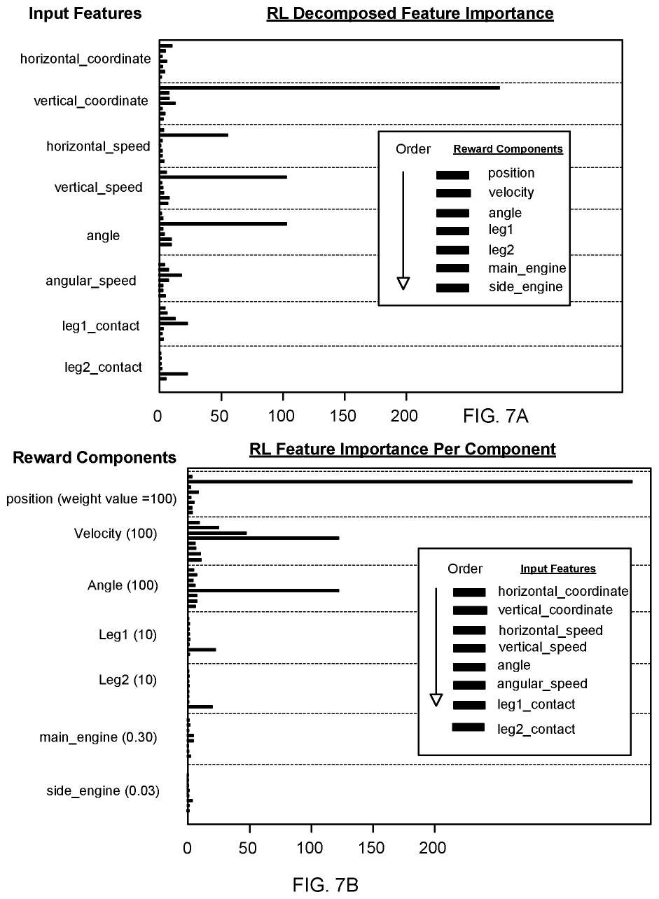

Also, in the embodiments of this disclosure, using the system 200, the weighted correlations between the input features and the reward component values can be determined as illustrated in FIGS. 7A and 7B. The weighted correlations are based on applying the reward component weight values of the reward components to the normalized correlations between the input features and the reward component values. Using the weighted correlations, one can determine which aspect of the system affects (e.g., the NN, the reward component weight values, or the combination of them) the final action of the RL agent.

Based on the outputs of the system 200 illustrated in FIGS. 6A-7B, the following findings can be made given that the reward component weight values assigned to the reward components are as shown in FIG. 7B.

(1) The “vertical_coordinate” input feature is the most contributing input feature for the RL behavior (the total reward) and it significantly affects the “position” reward component.

(2) The “leg1” and “leg2” reward components are correctly focused on the input features “leg1_contact” and the “leg2_contact,” respectively (which indicates that the NN performed well in focusing on the correct input features for the given reward components).

(3) The “leg1” and “leg2” reward components do not contribute significantly to the RL behavior (the total reward) because their weight values are just 10. On the contrary, the “position,” “velocity,” and “angle” reward components have higher priority in the reward function because their weight values are 100.

(4) The “horizontal_coordinate” and “angular_speed” input features do not have significant contribution in the NN. This information allows the user to take further action such as retraining the NN partially (e.g., making the “angular_speed” input feature to contribute more on the “side_engine” reward component) or remove these inputs features from the input of the RL agent.

(5) The “main_engine” and “side_engine” reward components have the least contribution to the total reward as well as in the NN side. Based on this information, a user may remove these reward components to make the NN more efficient. In case the user wants to increase the reward weight values, the user may still need to retrain the NN because it does not have any input feature that contributes significantly to the “main_engine” and “side_engine” components.

(6) In case there is a situation where the “leg1” and “leg2” reward components are more important than the “position” reward component, a user may transfer this NN model to other use case by only adjusting the weight values of the “leg1” and “leg2” reward components without retraining the NN from scratch.

Using the above information, it can be determined that the NN is performing well because 6 out of 8 input features give significant contribution to the total reward, and 5 out of 7 reward components focus on the correct features.

Having more granular explanation as illustrated in FIGS. 6A-7B allows user(s) to evaluate the performance of the NN and take appropriate further action with higher confidence.

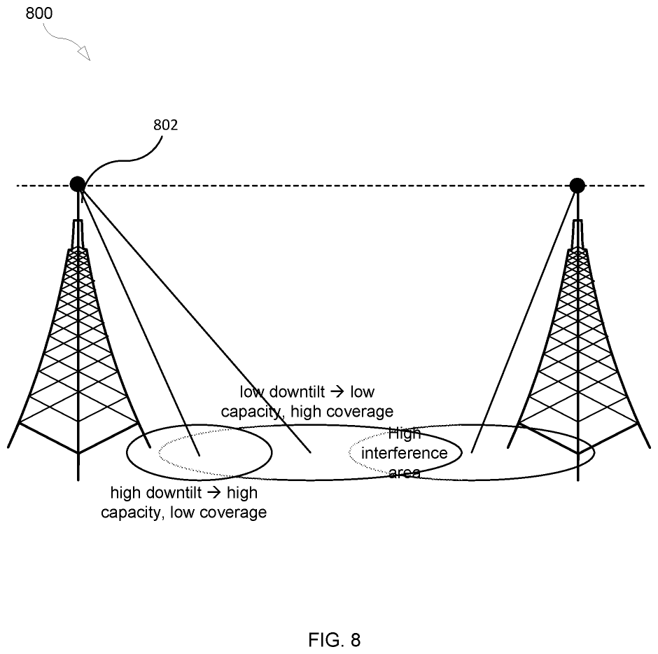

FIG. 8 shows another DRL environment 800 in which the system 200 can be used. In the DRL environment 800, an antenna 802 is configured to provide a wireless network and the RL agent is configured to control the operation of the antenna 802 in order to optimize the quality of the wireless network.

In the environment 800, the input features of the RL agent are statistical information about Signal to Interference and Noise Ratio (SINR) (percentile 10%, 50%, and 90%) and throughput (percentile 10%, 50%, and 75%) while the reward components are average SINR, traffic quality, average throughput, and weighted bitrate. The action to be decided by the RL agent is any one of tilting-up the antenna 802, maintaining the current orientation of the antenna 802, or tilting-down the antenna 802.

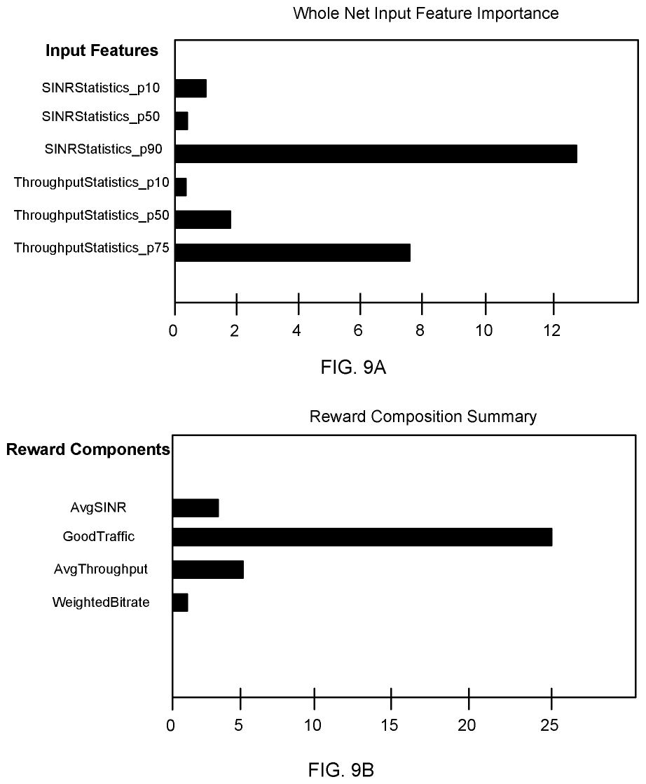

As shown in FIG. 9A, without using the system 200, only the contribution of each input feature to the total reward can be determined. Similarly, as shown in FIG. 9B, without using the system 200, only the contribution of each reward component to the total reward can be determined. In other words, without using the system 200, the contribution of each input feature to each reward component of the total reward cannot be determined.

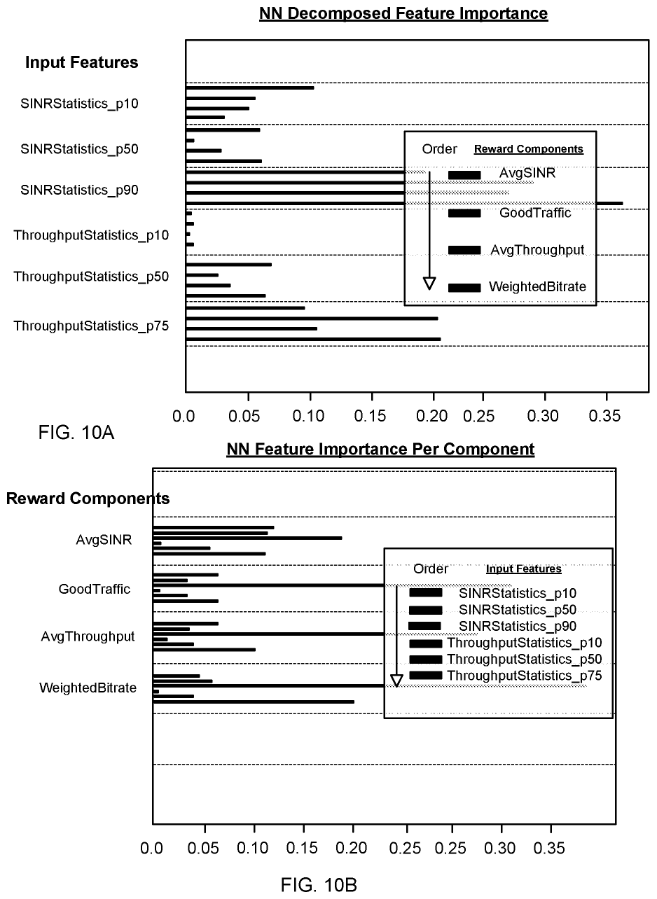

On the contrary, in the embodiments of this disclosure, using the system 200, the contribution of each input feature to each reward component can be determined as illustrated in FIGS. 10A and 10B, and thus the performance of the NN without considering the contribution of each reward component towards the total reward can be explained.

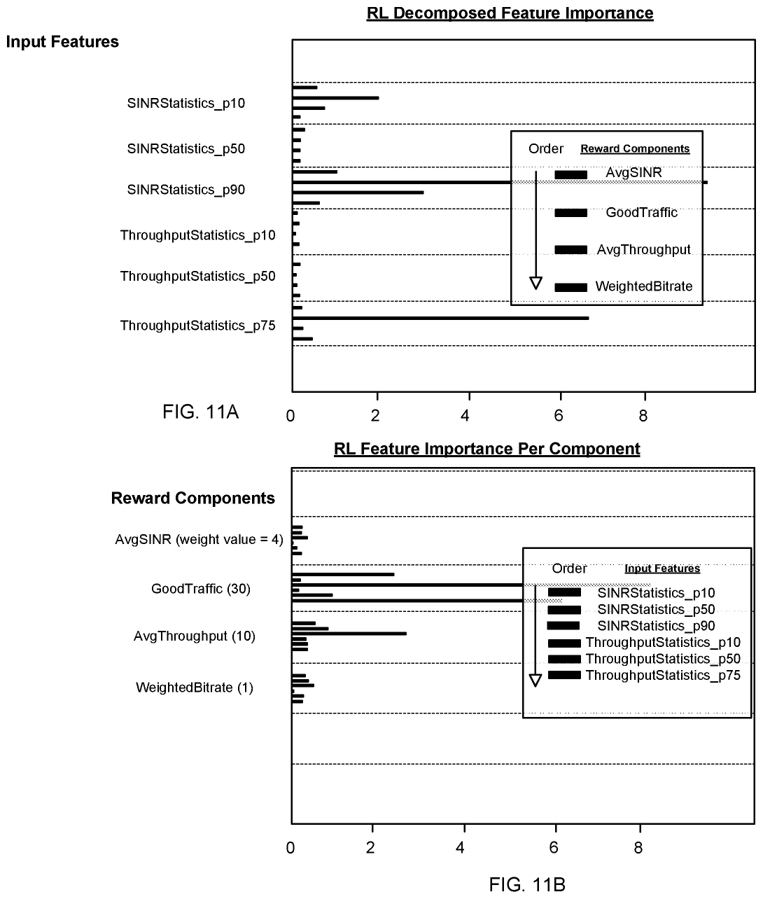

Also, in the embodiments of this disclosure, using the system 200, the weighted correlations between the input features and the reward component values can be determined as illustrated in FIGS. 11A and 11B. The weighted correlations are based on applying the reward component weight values of the reward components to the normalized correlations between the input features and the reward component values. Using the weighted correlations, one can determine which aspect of the system affects (e.g., the NN, the reward component weight values, or the combination of them) the final action of the RL agent.

Based on the outputs of the system 200 illustrated in FIGS. 10A-11B, the following findings can be made given that the reward component weight values assigned to the reward components are as shown in FIG. 11B.

(1) The “SINRStatistics_p90” input feature is the most important feature that significantly contributes to the “GoodTraffic” reward component. This is due to the high reward component weight value (i.e., 30) associated with the “GoodTraffic” reward component. As shown in FIGS. 10A and 10B, however, in the normalized value, the “SINRStatistics_p90” input feature provides slightly more contribution to the “WeightedBitrate” reward component than the “GoodTraffic reward component.”

(2) The “ThroughputStatistics_p10” input feature has the least contribution to each reward component. Based on this information, the user may retrain the RL agent (partially) or remove this input feature from the input to the RL agent in order to make the NN more efficient.

(3) The top two most important features for each reward component are the “SINRStatistics_p90” and the “ThroughputStatistics_p75” input features. As shown in FIGS. 10A and 10B, these input features have fairly similar contribution in the NN agent. Due to the prioritization of reward components, the “GoodTraffic” reward component has the most contribution to the total reward.

(4) The “ThroughputStatistics_p75” contributes to the “WeightedBitrate” and “GoodTraffic” reward components fairly similarly. This means that the NN does not have problem in training these components. However, due to the prioritization of the reward components, the “ThroughputStatistics_p75”'s actual contribution to the “WeightedBitrate” reward component is less than the actual contribution to the “GoodTraffic” reward component.

(5) The “AvgSINR” and “WeightedBitrate” reward components have the least contributions to the total reward. Without using the system 200, user(s) may not know for sure whether the small contributions are due to the problem in the NN training, reward prioritization, or both. However, using the system 200, the user can find out that the small contributions of the reward components are due to prioritizations of the reward components.

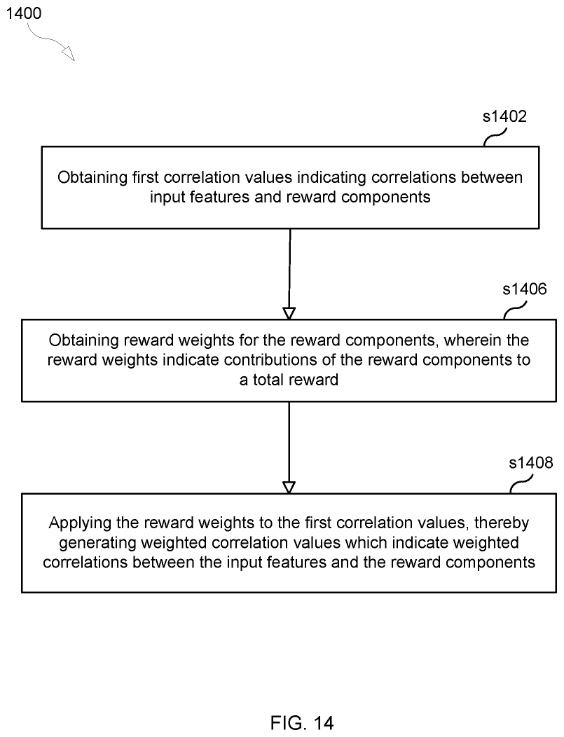

FIG. 14 shows a process 1400 according to some embodiments. The process 1400 may begin with step s1402. Step s1402 comprises obtaining first correlation values indicating correlations between input features and reward components. Step s1404 comprises obtaining reward weights for the reward components, wherein each of the reward weights indicates a contribution of each of the reward components to a total reward. Step s1406 comprises applying the reward weights to the first correlation values, thereby generating weighted correlation values which indicate weighted correlations between the input features and the reward components.

In some embodiments, the method further comprises obtaining current state information indicating a current state of an environment, obtaining a first set of quality values associated with a first reward component included in the reward components, and obtaining a second set of quality values associated with a second reward component included in the reward components, wherein each quality value included in the first set of quality values and the second set of quality values indicates a quality of an action to be performed by an agent given the current state of the environment.

In some embodiments, obtaining the first correlation values comprises generating the first correlation values based at least on the current state information, the first set of quality values, and the second set of quality values.

In some embodiments, the method further comprises using a neural network (NN) in a reinforcement learning (RL), determining an action to be performed by an agent given the current state of the environment, wherein the first correlation values are generated based at least on the determined action to be performed by the agent.

In some embodiments, the method further comprises obtaining a third set of quality values associated with the total reward, wherein each quality value included in the third set of quality values indicates a quality of an action to be performed by an agent given the current state of the environment, wherein obtaining the first set of quality values comprises generating the first set of quality values based at least on the third set of quality values and the reward weights, and obtaining the second set of quality values comprises generating the second set of quality values based at least on the third set of quality values and the reward weights.

In some embodiments, the method further comprises obtaining user-set correlation values indicating user-set correlations between input features and the reward components, wherein the user-set correlations are set by one or more users; and using the first correlation values and the user-set correlation values, calculating focus values (Fᵢ) each of which indicates a similarity between the first correlation values and the user-set correlation values.

In some embodiments, the first correlation values are included in an i×j matrix M, where i and j are positive integers, i indicates a number of the input features, j indicates a number of the reward components, the user-set correlation values are included in an i×j matrix N, and calculating the focus values (Fᵢ) comprises performing an element-wise multiplication of N and M matrices.

In some embodiments, each of the focus value is calculated as follows:

$${F}_{j} = \frac{{\sum }_{i} {M}_{ij} ⊙ {N}_{ij}}{{\sum }_{i} {M}_{ij}} .$$

In some embodiments, the method further comprises calculating a non-weighted mean value (U) based on the focus values and the number of the reward components.

In some embodiments, the non-weighted mean value is calculated as follows:

$$U = \frac{{\sum }_{j} {F}_{j}}{j} .$$

In some embodiments, the method further comprises calculating a weighted mean value based on the focus values, the number of the reward components, and the reward weights.

In some embodiments, the weighted mean value (W) is calculated as follows:

$$W = \frac{{\sum }_{j} {F}_{j} {R}_{j}}{{\sum }_{j} {R}_{j}} .$$

In some embodiments, the method further comprises obtaining a value of the total reward; and based on the obtained total reward value and the reward weights, calculating a normalized reward value for each of the reward components.

In some embodiments, the method further comprises obtaining a third set of quality values associated with the total reward, wherein each quality value included in the third set of quality values indicates a quality of an action to be performed by an agent given the current state of the environment; and updating the third set of set quality values using the normalized reward values.

In some embodiments, the method further comprises comprising transmitting towards a user or a network node the generated weighted correlation values.

In some embodiments, the method further comprises based on the generated weighted correlation values, revising a neural network configured to determine an action to be performed by an agent.

In some embodiments, the method further comprises revising the neural network comprises removing at least some of the input features from being used as inputs of the neural network.

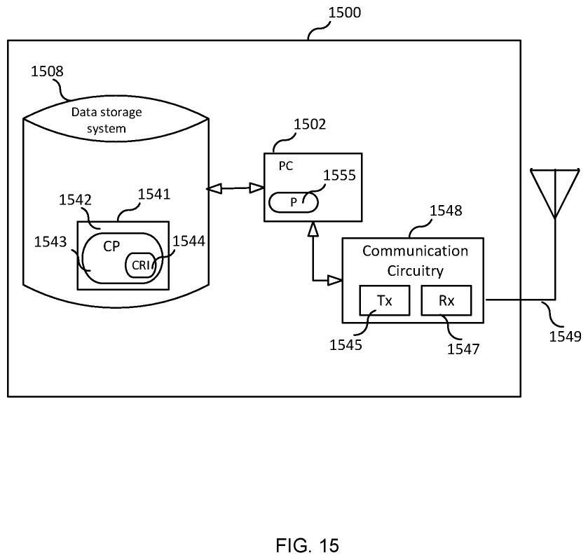

FIG. 15 is a block diagram of a system 1500, according to some embodiments. The system 1500 may be configured to perform the method 1400 shown in FIG. 14. As shown in FIG. 15, the system 1500 may comprise: processing circuitry (PC) 1502, which may include one or more processors (P) 1555 (e.g., one or more general purpose microprocessors and/or one or more other processors, such as an application specific integrated circuit (ASIC), field-programmable gate arrays (FPGAs), and the like); communication circuitry 1548, which is coupled to an optional antenna arrangement 1549 comprising one or more antennas and which comprises a transmitter (Tx) 1545 and a receiver (Rx) 1547 for enabling the system 1500 to transmit data and receive data (e.g., wirelessly transmit/receive data); and a local storage unit (a.k.a., “data storage system”) 1508, which may include one or more non-volatile storage devices and/or one or more volatile storage devices. In embodiments where PC 1502 includes a programmable processor, a computer program product (CPP) 1541 may be provided. CPP 1541 includes a computer readable medium (CRM) 1542 storing a computer program (CP) 1543 comprising computer readable instructions (CRI) 1544.

CRM 1542 may be a non-transitory computer readable medium, such as, magnetic media (e.g., a hard disk), optical media, memory devices (e.g., random access memory, flash memory), and the like. In some embodiments, the CRI 1544 of computer program 1543 is configured such that when executed by PC 1502, the CRI causes the system 1500 to perform steps described herein (e.g., steps described herein with reference to the flow charts). In other embodiments, the system 1500 may be configured to perform steps described herein without the need for code. That is, for example, PC 1502 may consist merely of one or more ASICs. Hence, the features of the embodiments described herein may be implemented in hardware and/or software.

While various embodiments are described herein, it should be understood that they have been presented by way of example only, and not limitation. Thus, the breadth and scope of this disclosure should not be limited by any of the above described exemplary embodiments. Moreover, any combination of the above-described elements in all possible variations thereof is encompassed by the disclosure unless otherwise indicated herein or otherwise clearly contradicted by context.

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

1. A computer-implemented method the method comprising:
obtaining first correlation values indicating correlations between input features and reward components;
obtaining reward weights for the reward components, wherein each of the reward weights indicates a contribution of each of the reward components to a total reward; and
applying the reward weights to the first correlation values, thereby generating weighted correlation values which indicate weighted correlations between the input features and the reward components.

2. The computer-implemented method of claim 1, comprising:
obtaining current state information indicating a current state of an environment;
obtaining a first set of quality values associated with a first reward component included in the reward components; and
obtaining a second set of quality values associated with a second reward component included in the reward components, wherein
each quality value included in the first set of quality values and the second set of quality values indicates a quality of an action to be performed by an agent given the current state of the environment.

3. The computer-implemented method of claim 2, wherein obtaining the first correlation values comprises generating the first correlation values based at least on the current state information, the first set of quality values, and the second set of quality values.

4. The computer-implemented method of claim 3, comprising using a neural network (NN) in a reinforcement learning (RL), determining an action to be performed by an agent given the current state of the environment, wherein
the first correlation values are generated based at least on the determined action to be performed by the agent.

5. The computer-implemented method of claim 2, comprising:
obtaining a third set of quality values associated with the total reward, wherein each quality value included in the third set of quality values indicates a quality of an action to be performed by an agent given the current state of the environment, wherein
obtaining the first set of quality values comprises generating the first set of quality values based at least on the third set of quality values and the reward weights, and
obtaining the second set of quality values comprises generating the second set of quality values based at least on the third set of quality values and the reward weights.

6. The computer-implemented method of claim 1, comprising:
obtaining user-set correlation values indicating user-set correlations between input features and the reward components, wherein the user-set correlations are set by one or more users; and
using the first correlation values and the user-set correlation values, calculating focus values (Fⱼ) each of which indicates a similarity between the first correlation values and the user-set correlation values.

7. The computer-implemented method of claim 6, wherein
the first correlation values are included in an i×j matrix M, where i and j are positive integers,
i indicates a number of the input features,
j indicates a number of the reward components,
the user-set correlation values are included in an i×j matrix N, and
calculating the focus values (Fⱼ) comprises performing an element-wise multiplication of N and M matrices.

8. The computer-implemented method of claim 7, wherein each of the focus value is calculated as follows:
$${F}_{j} = \frac{{\sum }_{i} {M}_{ij} ⊙ {N}_{ij}}{{\sum }_{i} {M}_{ij}} .$$

9. The computer-implemented method of claim 7, the method further comprising:
calculating a non-weighted mean value (U) based on the focus values and the number of the reward components.

10. The computer-implemented method of claim 9, wherein the non-weighted mean value is calculated as follows:
$$U = \frac{{\sum }_{j} {F}_{j}}{j} .$$

11. The computer-implemented method of claim 7, the method further comprising:
calculating a weighted mean value based on the focus values, the number of the reward components, and the reward weights.

12. The computer-implemented method of claim 11, wherein the weighted mean value (W) is calculated as follows:
$$W = \frac{{\sum }_{j} {F}_{j} {R}_{j}}{{\sum }_{j} {R}_{j}} .$$

13. The computer-implemented method of claim 1, comprising:
obtaining a value of the total reward; and
based on the obtained total reward value and the reward weights, calculating a normalized reward value for each of the reward components.

14. The computer-implemented method of claim 13, comprising:
obtaining a third set of quality values associated with the total reward, wherein each quality value included in the third set of quality values indicates a quality of an action to be performed by an agent given the current state of the environment; and
updating the third set of set quality values using the normalized reward values.

15. The computer-implemented method of claim 1, further comprising transmitting towards a user or a network node the generated weighted correlation values for updating a machine learning, ML model.

16. The computer-implemented method of claim 1, further comprising, based on the generated weighted correlation values, revising a neural network configured to determine an action to be performed by an agent.

17. The computer-implemented method of claim 16, wherein revising the neural network comprises removing at least some of the input features from being used as inputs of the neural network.

18. The computer-implemented method of claim 15, wherein updating the ML model comprises removing at least one input feature from the input features and/or adjusting at least one reward weights for at least one reward component in the reward components.

19-22. (canceled)

23. A computing device comprising:
a memory; and
processing circuitry coupled to the memory, wherein the computing device is configured:
obtain first correlation values indicating correlations between input features and reward components;
obtain reward weights for the reward components, wherein each of the reward weights indicate a contribution of each of the reward components to a total reward; and
apply the reward weights to the first correlation values, thereby generating weighted correlation values which indicate weighted correlations between the input features and the reward components.

24. A computer program product comprising a non-transitory computer readable medium storing instructions which when executed by processing circuitry of a system causes the system to perform a process that comprises:
obtaining first correlation values indicating correlations between input features and reward components;
obtaining reward weights for the reward components, wherein each of the reward weights indicates a contribution of each of the reward components to a total reward; and
applying the reward weights to the first correlation values, thereby generating weighted correlation values which indicate weighted correlations between the input features and the reward components.
